(19) United States
(12) Patent Application Publication
(10) Pub. No.: US 2004/0024481 A1
(43) Pub. Date: Feb. 5, 2004

(54) Computer-aided system for monitoring production

(76) Inventor: Raphael Labourier, Besancon (FR)

Correspondence Address: YOUNG & THOMPSON, 745 SOUTH 23RD STREET 2ND FLOOR, ARLINGTON, VA, 22202

(21) Appl. No.: 10/380,540

(22) PCT Filed: Sep. 17, 2001
(86) PCT No.: PCT/FR01/02883

(30) Foreign Application Priority Data
Sep. 15, 2000 (FR) 00/12202

(51) Int. Cl. G06F 19/00

(52) U.S. Cl. 700/108

(57) ABSTRACT

A computer-aided system for monitoring production of one or several machines (2, 3, 4) includes at least a primary real-time system (1, 1′) comprising at least an input connected to at least a machine (2, 3, 4) and/or to at least a secondary real-time system (2a, 3a, 4a) of the machine(s) (2, 3, 4) and at least an output connected to at least a server (5). The primary real-time system (1, 1′) and/or the secondary real-time system (2a, 3a, 4a) comprise a programme designed to determine the operating mode of the machine (2, 3, 4) and/or the operating time in each of the modes, the server (5) formatting in the form of Web pages the data of the primary real-time system (1, 1′) to supply them to client computers (6, 7, 8) which are connected to the server (5).

The present invention relates to a production monitoring system making it possible to manage a variable number of machines and to process the data issued by the machines in real time which allows updating in real time of the data to be given to the operators of the machines, but also to transmit the production data to the different production, quality, etc. . . . services in real time.

In the domain of production monitoring, systems are well known which are constituted by a box connected to one or a plurality of machines—machine is understood to mean industrial production equipment which may be piloted by conventional electrical equipment, a programmable automat or a numeric control -, said box comprising a keyboard for entry and a display screen with from two to eight lines of characters. Each box comprises a microprocessor in which is recorded a programme making it possible to effect counting of the pieces produced by the machine connected to said box, to determine the operating mode and to record the faults occurring on the machine, the operating mode and the collection of the faults being able to be entered in by the operator from the keyboard. The data on piece counting, operating mode and faults make it possible to determine the operating times of the machine in each of its working modes as well as the data relative to the order of manufacture, these latter data being able to be read either at the level of the box or on a PC type computer connected to said box; this is what is called computer-aided production monitoring, or CAPM.

Such CAPM systems comprising such boxes present numerous drawbacks; in effect, these boxes generally comprise a finite and limited number of inputs, i.e. a limited number of possibilities of connecting machines, with the result that it is difficult to adapt a box as a function of the development of the needs of industrialists, particularly upon an increase in the number of machines or a modification of the machines where it is generally necessary to change the boxes which are particularly expensive. Another drawback consists in the fact that the programmes of these boxes are created in microprocessor language. This particularly difficult data-processing language thus rendering a reprogrammation of the box difficult, long and consequently expensive. Finally, these boxes present a cycle time greater than or equal to 100 ms which, taking into account the rates of present-day machines, does not make it possible to process all the data coming from all the machines connected to the box.

One of the objects of the invention is therefore to overcome all these drawbacks by providing a computer-aided production monitoring system which is reliable, easily adaptable to the evolutions of the machines or of the data necessary for monitoring production, and inexpensive.

In this respect and according to the invention, the computer-aided system for monitoring production of one or a plurality of workshops or production lines comprising respectively one or a plurality of machines, is noteworthy in that it is constituted by at least one “primary” real-time system comprising at least one input connected to at least one machine and/or to at least one secondary real-time system of the machine(s) and at least one output connected to at least one server, said “primary” real-time system and/or said “secondary” real-time system of the machine(s) comprising a programme designed to determine the operating modes of said machine and/or the operating times in each of these modes, the server formatting in the form of “Web” page the data of the real-time system to place them at the disposal of client computers of the different production, quality or like services which are connected to the server by an “Intranet” or “Ethernet” network and equipped with “Web” navigators called “browser” to read said “Web” pages.

It is readily understood that the real-time system which advantageously consists in a programmable automat or in the real-time part of a computer of PC type, allows considerable flexibility of adaptation and presents a cycle time less than 20 ms which makes it possible to process all the data coming from the machines. En effect, a programmable automat or a real-time part of a PC computer may receive a variable number of inputs, i.e. connection to machines, and use programmation languages which are easy to handle, with the result that it is not necessary to change the production monitoring system when production develops, such as when new machines are added for example, but simply to reprogramme it.

According to a particularly advantageous variant embodiment of the production monitoring system, it comprises a light client constituted by a computer of PC type comprising a screen, a keyboard and a central unit without hard disc, and connected to the server allowing the operators of the machines to enter the causes of stop of the machine or machines and to display data relative to the production underway and quality, production or assembly slips.

Other advantages and characteristics will appear more readily from the following description of several variant embodiments, given by way of non-limiting examples, of the computer-aided production monitoring system, with reference to the accompanying drawings, in which:

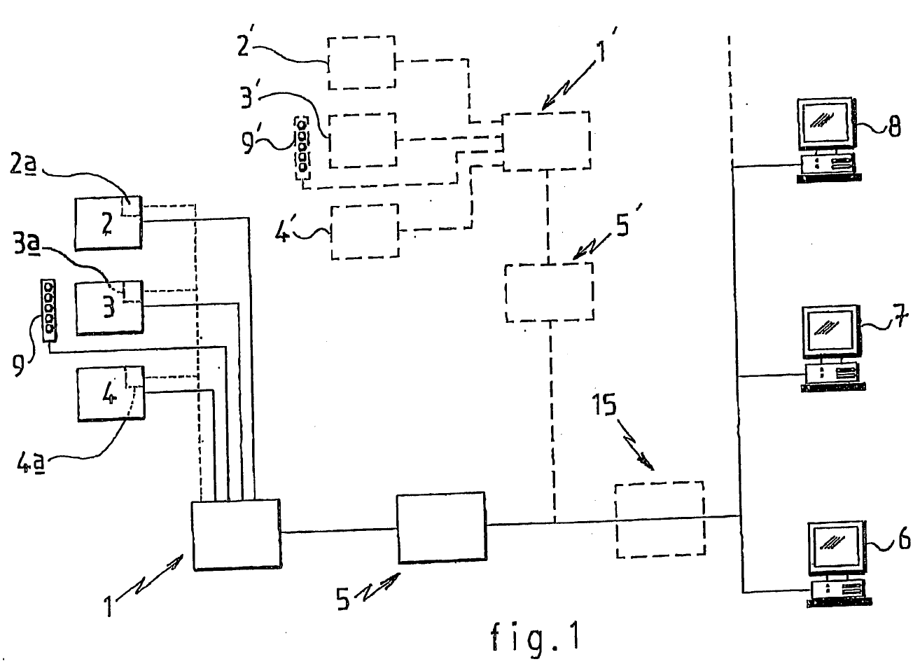

FIG. 1 schematically shows the computer-aided production monitoring system according to the invention.

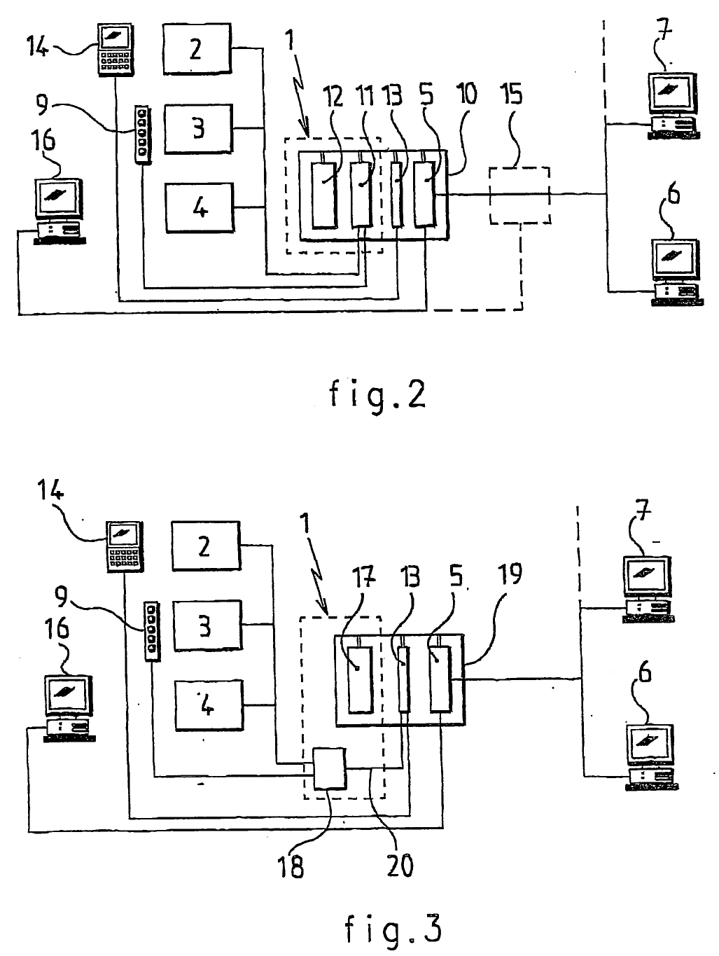

FIG. 2 schematically shows a first variant embodiment of the computer-aided monitoring system according to the invention.

FIG. 3 is a second variant embodiment of the computer-aided production monitoring system according to the invention.

A non-limiting example of a computer-aided system for monitoring production of a plurality of industrial machines will now be described.

With reference to FIG. 1, the production monitoring system is constituted by a “primary” real-time system 1 comprising a plurality of inputs respectively connected to a machine 2, 3 and 4 and at least one output connected to a server 5, said primary real-time system comprising a programme adapted to determine the cycle time of each machine from a taking of data of the “All or Nothing” or AON type such as the piece counting data taken on the machines. The counting datum which, on the machine, consists in an electrical pulse, is transformed into a binary datum of 0 or 1 type which allows the programme of the “primary” real-time system 1 to determine the counting of the pieces and the cycle time, then to deduce therefrom the operating modes of said machine, for example: the first datum of the cycle gives the adjustment mode, an automatic mode is deduced at the end of a certain number of cycle times and a stop mode is deduced after the absence of pulses during a predetermined number of cycles. Furthermore, the programme of the “primary” real-time system 1 determines the operating time of the machine in each of the modes described previously. The data received by the “primary” real-time system 1 as well as the data which are deduced therefrom are transmitted to the server 5 which formats “Web” pages, i.e. in the form of extension .html data files or the like, to place them at the disposal of the client computers 6, 7 and 8 of the different production, quality or like services which are connected to the server 5 by an “Intranet” or “Ethernet” network and equipped with “Web” navigators commonly called “browsers”, such as “Netscape” or “Internet Explorer” which are registered Trademarks, in order to read said “Web” pages.

Furthermore, it will be noted that the “Web” pages of the server 5 can be read by any “browser” and this, whatever the operating systems of the client computers likely to read them.

According to a first variant embodiment of the production monitoring system according to the invention, with reference to FIG. 1, the machines 2, 3 and 4 advantageously comprise so-called “secondary” real-time systems 2a 3a and 4a respectively, networked at the input of the “primary” real-time system 1. In the same way as hereinbefore, the “secondary” real-time systems 2a, 3a and 4a respectively comprise a programme adapted to determine the counting of pieces and/or the cycle time from a taking of binary data such as the piece counting datum taken on the machines 2, 3 and 4 then to deduce therefrom the operating mode of said machines 2, 3 and 4 and/or the operating time in each of the cycles. In this way, it will be noted that the “secondary” real-time systems 2a, 3a and 4a effecting a part of the data processings, the primary real-time system 1 is liberated from a part of said processings, which makes it possible to connect to said “primary” real-time system 1 a larger number of machines comprising a “secondary” real-time system or not, while conserving a data processing cycle time less than 20 ms.

In accordance with a second variant embodiment of the production monitoring system according to the invention, the operating mode of the machines 2, 3 and 4 is directly transmitted to the “primary” real-time system by said machines 2, 3 or 4 or by the operators of these latter by means for example of a control desk or box which will be described in greater detail hereinafter.

Furthermore, a second primary real-time system 1′, on the inputs of which are connected machines 2′, 3′ and 4′, may advantageously be connected to a server 5′, the servers 5 and 5′ in that case being networked. Moreover, control buttons 9 and 9′ may advantageously be positioned to the side of the machines 3 and 3′ respectively and connected to the real-time systems 1 and 1′ respectively in order to procure therefor complementary data such as for example a cause of stop relative to said machines 3 and 3′.

In accordance with another, particularly advantageous variant embodiment of the production monitoring system according to the invention, with reference to FIG. 2, the “primary” real-time system 1 consists in a programmable automat comprising a chassis 10 enclosing an input/output unit 11 and a central unit 12 commonly called CPU which is the abbreviation of Control Process Unity (sic). Furthermore, the input/output unit 11, the central unit 12 and a coupler 13 are connected to the chassis 10 in order to allow the transfer of data between the input/output unit 11 and the central unit 12, in particular.

It goes without saying that the input/output unit 11 may be offset with respect to the chassis 10, i.e. positioned outside said chassis 10, said input/output unit 11 in that case being connected to the coupler 13 by a ground bus without departing from the scope of the invention.

Furthermore, it will be noted that the programmable automat 1 is a particularly reliable machine which presents a cycle time less than 20 ms, and even less than 10 ms depending on the constructors, and which presents the advantage of being easily programmable. In this non-limiting example of embodiment, machines 2, 3 and 4 are connected to the inputs of the unit 11 of the programmable automat 1, each machine being connected to an input of said unit 11, and the server 5, which consists in a microprocessor card bearing a programme and connected to the automat 1, is positioned in the chassis 10 of said automat 1, the server 5 likewise being connected to the chassis 10. As has already been seen, the data received by the automat 1 are transmitted to the server 5 which, via its data-processing programme, formats in the form of “Web” pages said data in order to place them at the disposal of the client computers 6, 7 and 8 of the different production, quality or like services which are connected to the server 5 by an “Intranet” or “Ethernet” network . . . .

Furthermore, the computer-aided production monitoring system comprises a control box 9 connected to the input/output unit 11 of the programmable automat 1 and positioned to the side of the machine 3 in order to procure complementary data such as for example a cause of stop relative to said machine 3. The production monitoring system advantageously comprises one or more operator control desks 14, of which only one is shown in FIG. 2 to the side of machine 2, connected to the programmable automat 1 by the coupler 13 and constituted for example by a display screen of 16 characters and by a keyboard. This operator control desk 14 allows the operator of the machine 2 to enter a cause of stop and possibly to display or enter the quantities discarded by said machine, the orders of manufacture or the references.

According to a variant embodiment of the system according to the invention, the operator control desk 14 consists in a bar code reader connected to the coupler 13 by a link by wire or radio.

Moreover, it is obvious that the operator control desk 14 may consist in a simple touch screen, the keyboard in that case being on the screen.

With reference to FIGS. 1 and 2, the computer-aided production monitoring system comprises an “Intranet” server 15 connected between the “Web” page servers 5 and the client computers 6, 7 and 8 in order to allow the recording of the data in a data base offering greater memory and data-processing capacities. In effect, the memory capacity of the server 5 corresponds to about a week of collected data, which is not always sufficient for an improved product monitoring which sometimes requires comparing the production of one month with respect to another.

Furthermore, with reference to FIG. 2, a light client 16 is advantageously connected to the “Web” server 5 or to the Intranet server 15 positioned to the side of the machine 4 allowing its operator to enter the causes of stop of said machine 4 and to display data relative to the production underway, quality, production, assembly, adjustment, maintenance slips, or plans, photos, etc . . . . The light client 16 consists in a computer of PC type not having a hard disc, i.e. a computer comprising a screen, a keyboard and a central unit constituted by a mother card and cards for connection of the peripherals, such as a video card, a sound card, etc. Furthermore, these light clients 16 allow the operators to modify certain parameters of the programme of the server 5 such as, for example, the theoretical cycle time of a machine or the theoretical number of pieces per cycle.

It goes without saying that, for monitoring production of a machine comprising an integrated programmable automat, the “Web” page server may advantageously be connected to the programmable automat of the machine 4, said server 5 in that case consisting in a microprocessor card connected to the output of the automat inside its chassis, without departing from the scope of the invention.

Moreover, it is obvious that the light client 16 may consist in a computer of PC type constituted by a screen, a keyboard, a central unit and a network card, said computer being equipped with a “browser”.

Furthermore, for monitoring production of machines 2, 3 and 4 comprising integrated “secondary” real-time systems 2a, 3a, 4a such as shown in FIG. 1, the control box 9, the operator control desk 14 and the light client 16 may advantageously be connected to said “secondary” real-time systems 2a, 3a, 4a without departing from the scope of the invention.

In accordance with a last variant embodiment of the production monitoring system according to the invention, with reference to FIG. 3, the “primary” real-time system 1 consists in the real-time part 17 of a computer of PC type such as “hardware”, i.e. the data-processing material, or “software”, i.e. software, and an input/output unit 18. In this particular example of embodiment, the real-time part 17, the server 5 and the coupler 13 are positioned inside the chassis 19 of the computer and are connected to said chassis 19 in order to allow the transfer of data between the real-time part 17 and the server 5 in particular. The input/output unit 18 which, in this variant embodiment, is offset, i.e. positioned outside the chassis 19 and on which are connected the machines 2, 3 and 4, is connected to the coupler 13 by a ground bus 20 such as, for example, Modbus, Profibus, etc . . . . In the same way as previously, the production monitoring system comprises a control box 9 connected to the “primary” real-time system 1 via the input/output unit 18 and/or an operator control desk 14 connected to the coupler 13 and/or a light client 16 connected to the server 5. It will be noted that, in this variant embodiment, the server 5 may advantageously perform simultaneously the function of “Web” page server and the functions of “Intranet” server 15 comprising a data base, described hereinbefore.

It goes without saying that the computer-aided production monitoring system may advantageously comprise analogue measuring devices positioned on the machines 2, 3 and 4 and connected to the “primary” real-time system 1 in order, for example, to control the quality of the pieces and possibly to sort them. The data emitted by these analogue measuring devices are thus transmitted to the “primary” real-time system 1 then to the server 5 which places them at the disposal of the client computers 6, 7 and 8 in the form of “Web” pages thus allowing management of the quality, in addition to the production management, to be effected.

Moreover, it is obvious that the input of the “primary” real-time system 1 consists in a connection of the “all or nothing” or like type and that its output consists either in a connection of the data-processing bus type, or in a connection of Ethernet type.

Finally, it goes without saying that the computer-aided production monitoring system may be adapted to all types of machines, such as numerical control machines, for example, and that the examples which have just been given are only particular illustrations, in no way limiting, of the domains of application of the invention.

1. Computer-aided system for monitoring production of one or more workshops or production lines comprising respectively one or more machines (2, 3, 4), characterized in that it is constituted by at least one “primary” real-time system (1, 1′) comprising at least one input connected to at least one machine (2, 3, 4) and/or to at least one secondary real-time system (2a, 3a, 4a) of the machine(s) (2, 3, 4) and at least one output connected to at least one server (5), said “primary” real-time system (1) and/or said “secondary” real-time system (2a, 3a, 4a) of the machine(s) (2, 3, 4) comprising a programme designed to determine the operating modes of said machine (2, 3, 4) and/or the operating times in each of these modes, the server (5) formatting in the form of “Web” page the data of the “primary” real-time system (1, 1′) to place them at the disposal of client computers (6, 7, 8) of the different production, quality or like services which are connected to the server (5) by an “Intranet” or “Ethernet” network and equipped with “Web” navigators called “browser” to read said “Web” pages.

2. Computer-aided production monitoring system according to claim 1, characterized in that the “primary” real-time system (1, 1′) and/or the “secondary” real-time system (2a, 3a, 4a) comprises a programme adapted to determine the counting of pieces and/or the cycle time from a taking of binary data such as the piece counting datum taken on the machine (2, 3, 4) then to deduce therefrom the operating mode of said machine (2, 3, 4) and/or the operating time of each of the cycles.

3. Computer-aided production monitoring system according to claim 1, characterized in that the operating mode of the machine (2, 3, 4) is directly transmitted to the “primary” real-time system (1, 1′) by the machine (2, 3, 4) or by the operator of the latter.

4. Computer-aided production monitoring system according to any one of the preceding claims, characterized in that the “primary” real-time system (1, 1′) consists in a programmable automat comprising a central unit (12) and an input/output unit (11) enclosed in a chassis (10).

5. Computer-aided production monitoring system according to any one of claims 1 to 3, characterized in that the “primary” real-time system (1, 1′) consists in the real-time part (17) enclosed in a chassis (19) of a computer of PC type and an input/output unit (18).

6. Computer-aided production monitoring system according to any one of the preceding claims, characterized in that the server (5) is positioned in the chassis (10, 19) of the “primary” real-time sytsem (1, 1′), the server (5) in that case consisting in a microprocessor card bearing a programme connected to the “primary” real-time system (1, 1′).

7. Computer-aided production monitoring system according to claim 4, characterized in that the “primary” real-time system (1, 1′) consists in the programmable automat of a machine, the server (5) in that case consisting in a microprocessor card bearing a programme connected to the output of the automat of said machine (4).

8. Computer-aided production monitoring system according to any one of the preceding claims, characterized in that the input/output unit (11, 18) of the “primary” real-time system (1, 1′) is positioned outside its chassis (10, 19), said input/output unit (11, 18) being connected to the “primary” real-time system (1, 1′) by ground buses.

9. Computer-aided production monitoring system according to any one of claims 1, 2 and 4 to 12, characterized in that it comprises an “intranet” server (15) connected between the server or servers (5) and the client computers (6, 7, 8).

10. Computer-aided production monitoring system according to any one of the preceding claims, characterized in that it comprises a light client (16) connected to the server (5) or (15) allowing the operators to enter the causes of stop of the machine(s) (2, 3, 4) and to display data relative to the production underway, quality, production, assembly, adjustment, maintenance slips or photos, plans, etc . . . .

11. Computer-aided production monitoring system of claim 10, characterized in that the light client (16) is constituted by a computer of the PC type comprising a screen, a keyboard, a central unit without hard disc and a network card of the ethernet type.

12. Computer-aided production monitoring system of claim 10, characterized in that the light client (16) consists in a computer of the PC type constituted by a screen, a keyboard, a central unit and a network card and equipped with a “browser”.

13. Computer-aided production monitoring system according to any one of claims 10 to 12, characterized in that the light client (16) is connected to the server (5) or (15) by a link by wire or by a radio-frequency link.

14. Computer-aided production monitoring system according to any one of the preceding claims, characterized in that it comprises operator control desks (14) networked to the “primary” real-time system (1, 1′) and/or to the secondary real-time system (2a, 3a, 4a) allowing the operator to enter a cause of stop of the machine (2, 3, 4) and possibly to display or enter the quantities discarded by the machine, the orders of manufacture or the references.

15. Computer-aided production monitoring system according to claim 14, characterized in that the operator control desk (14) consists in a bar code reader connected to the “primary” real-time sytsem (1, 1′) and/or to the “secondary” real-time system (2a, 3a, 4a) by a link by wire or radio.
